(19) United States
(12) Patent Application Publication
(10) Pub. No.: US 2021/0027038 A1
(43) Pub. Date: Jan. 28, 2021

(54) DISPLAY PANEL CONTROL SYSTEM AND DISPLAY PANEL CONTROL METHOD

(71) Applicant: Chuan Shuai, (US)

(72) Inventor: Chuan Shuai, (US)

(21) Appl. No.: 16/637,961

(22) PCT Filed: Oct. 17, 2019
(86) PCT No.: PCT/CN2019/111658

§ 371 Date: Feb. 10, 2020

(30) Foreign Application Priority Data
Jul. 26, 2019 (CN) 201910684493.8

(51) Int. Cl. G06K 9/00; G02F 1/1334; G02F 1/1333; G06K 9/20

(52) U.S. Cl. CPC G06K 9/00013; G02F 1/1334; G02F 1/133528; G06K 9/2027; G02F 1/13338

(57) ABSTRACT

A display panel control system and a display panel control method are provided. The display panel control system includes a display unit, a sensing unit, a control unit, and a sensor unit. A plurality of light transmitting holes formed in the touch area when the display unit is being touched, and the display unit to display the images when the display unit is not being touched. The sensor unit is configured to receive the fingerprint signals passing through the light transmitting holes and to collect fingerprint images. The display panel control method includes a display step, a sensing step, a controlling step, and a fingerprint image acquisition step. In the present disclosure, 100% comprehensive screen fingerprint recognition is realized without affecting the display function, and the screen ratio is improved.

### FIELD OF INVENTION

The present disclosure relates to the display field, and in particular, relates to a display panel control system and a display panel control method.

### BACKGROUND OF INVENTION

With the improvement of mobile phone process design capabilities, consumer aesthetics are constantly being guided and promoted. The mobile phone screen has been gradually converted into a full-screen design from the previous diversified design. Therefore, the design capability and process capability of the comprehensive screen related indicators in displays, such as chips on flexible circuit boards (COF), ultra-narrow bezels, notches, etc, are continuously improved, and the screen ratio has gradually increased from 80% to 97%. The research on fingerprint recognition in the screen is particularly popular, which directly integrates the fingerprint module into the screen, and the screen ratio is greatly increased.

In order to increase the screen ratio, the existing solution in the liquid crystal display has serious defects in the imaging of the fingerprint sensor. For example, the image quality of the pinhole imaging solution is poor, or in order to optimize the pinhole imaging solution, the normal display function is affected.

As a result, it is necessary to provide a display panel control system and a display panel control method to achieve full screen pinhole imaging solution fingerprint recognition without affecting the display function.

### SUMMARY OF INVENTION

An object of the present disclosure is to provide a display panel control system and a display panel control method, 100% comprehensive screen fingerprint recognition is realized without affecting the display function, and the screen ratio is improved.

To achieve the above object, the present disclosure provides a display panel control system. The display panel control system includes a display unit, a sensing unit, a control unit, and a sensor unit, wherein the display unit is configured to display images, the sensing unit is electrically-connected to the display unit and configured to sense a touch area where the display unit is touched, the control unit is electrically-connected to the display unit and the sensing unit, wherein the control unit is configured to control a plurality of light transmitting holes formed in the touch area used for fingerprint signals to pass through when the display unit is touched, and the control unit is configured to control the display unit to display the images when the display unit is untouched, and the sensor unit is electrically-connected to the control unit, disposed corresponding to the display unit, and configured to receive the fingerprint signals passing through the light transmitting holes and to collect fingerprint images.

Further, the sensor unit includes a plurality of sensors arranged in an array, and the sensors are disposed in one-to-one correspondence with the light transmitting holes.

Further, the sensor includes one of a fingerprint scanner sensor, a camera sensor, a light sensor, and a distance sensor, or includes a combination thereof.

Further, the display unit includes a first substrate, a second substrate disposed opposite to the first substrate, and a liquid crystal layer disposed between the first substrate and the second substrate.

Further, a material of the liquid crystal layer includes a polymer dispersed liquid crystal, and the polymer dispersed liquid crystal includes a plurality of liquid crystal molecules and a plurality of reticulated polymers; the first substrate includes an array substrate, and the second substrate includes a color film substrate and a polarizer disposed at a side of the color film substrate facing away from the liquid crystal layer.

Further, a material of the liquid crystal layer includes thermotropic liquid crystal or lyotropic liquid crystal, and the liquid crystal includes a biphenyl liquid crystal, a phenylcyclohexane liquid crystal, or an ester liquid crystal; the first substrate includes an array substrate and a lower polarizer disposed at a side of the array substrate facing away from the liquid crystal layer, and the second substrate includes a color film substrate and a upper polarizer disposed at a side of the color film substrate facing away from the liquid crystal layer.

The present disclosure further provides a display panel control method. The display panel control method includes a display step of disposing a display unit being configured to display images, a sensing step of sensing a touch area where the display unit is touched, a controlling step of controlling a plurality of light transmitting holes formed in the touch area to cause the display unit being used for fingerprint signals to pass through when the display unit is touched, and controlling the display unit to display the images when the display unit is untouched, and a fingerprint image acquisition step of receiving the fingerprint signals passing through the light transmitting holes, collecting fingerprint images, and returning to the display step after the fingerprint images are collected.

Further, the controlling step comprises: when the display unit is touched, applying a voltage to the liquid crystal layer located in the touch area to cause a plurality of liquid crystal molecules to twist to form the light transmitting holes in a transparent state.

Further, a material of the liquid crystal layer includes a polymer dispersed liquid crystal, and the polymer dispersed liquid crystal includes the liquid crystal molecules and a plurality of reticulated polymers; when no voltage is applied, an optical axis of the liquid crystal molecules are randomly oriented to form a disordered state and incident light is scattered, so that the liquid crystal layer is in a fog state; when a voltage is applied, the optical axis of the liquid crystal molecules are arranged perpendicular to a plane of the liquid crystal layer, so that the liquid crystal layer forms the light transmitting holes being in a transparent state.

Further, the fingerprint image acquisition step includes a step of disposing a sensor unit, and the sensor unit includes a plurality of sensors arranged in an array, and the sensors are disposed in one-to-one correspondence with the light transmitting holes.

An advantage of the present disclosure is to provide a display panel control system and a display panel control method. The fingerprint images are acquired by detecting the touch area and forming the light transmitting holes in the corresponding touch area, and the images are displayed when the display unit is not being touched. The liquid crystal layer of the present disclosure changes the transparent and opaque state according to the touch condition. 100% comprehensive screen fingerprint recognition is realized without affecting the display function, and the screen ratio is improved.

### DESCRIPTION OF DRAWINGS

FIG. 1 is a schematic structural view of a display panel control system according to an embodiment of the present disclosure.

FIG. 2 is a cross-sectional view showing a display panel according to a first embodiment of the present disclosure.

FIG. 3 is a schematic structural view of a touch area being in a full screen mode according to an embodiment of the present disclosure.

FIG. 4 is a schematic structural view of a touch area being in a non-full screen mode according to an embodiment of the present disclosure.

FIG. 5 is a cross-sectional view showing a display panel according to a second embodiment of the present disclosure.

FIG. 6 is a flowchart of a control method of a display panel according to an embodiment of the present disclosure.

FIG. 7 is a schematic view of a porous splicing boundary of a fingerprint image according to an embodiment of the present disclosure.

Components in the figures are identified as follows:
1. first substrate, 2. second substrate, 3. liquid crystal layer, 4. light transmitting hole,
11. array substrate, 12. lower polarizer, 21A, 21B. color film substrate,
22. polarizer, 23. upper polarizer, 10. display unit, 20. sensing unit,
30. control unit, 40. sensor unit, 41. sensor, 50. light transmitting area,
60. fingerprint image, 61. edge stitching, 62. convex stitching, 63. peripheral stitching,
100. display panel control system.

### DETAILED DESCRIPTION OF PREFERRED EMBODIMENTS

In the present disclosure, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on,” “above,” or “on top of” a second feature may include an embodiment in which the first feature is right or obliquely “on,” “above,” or “on top of” the second feature, or just means that the first feature is at a height higher than that of the second feature; while a first feature “below,” “under,” or “on bottom of” a second feature may include an embodiment in which the first feature is right or obliquely “below,” “under,” or “on bottom of” the second feature, or just means that the first feature is at a height lower than that of the second feature.

In the present disclosure, the same or corresponding components are denoted by the same reference numerals and are not related to the figure number. In the specification, these components are not necessarily limited to the above when the terms “first”, “second”, etc. are used to describe various components. The above terms are only used to distinguish one component from another.

### Embodiment 1

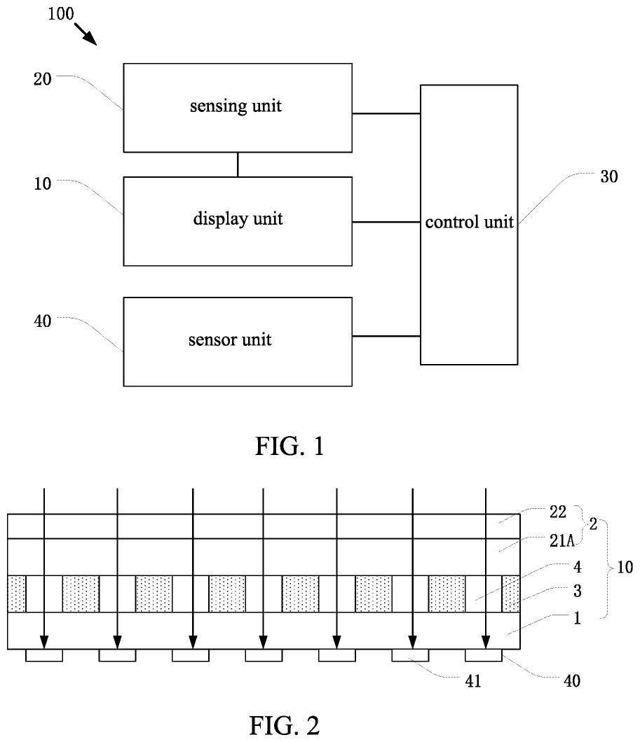

Referring to FIG. 1, a schematic structural view of a display panel control system according to a first embodiment of the present disclosure is illustrated. The display panel control system 100 includes a display unit 10, a sensing unit 20, a control unit 30, and a sensor unit 40. Specifically, the display unit 10 is configured to display images. The sensing unit 20 is electrically-connected to the display unit 10 and configured to sense a touch area where the display unit 10 is touched, wherein the sensing unit 20 includes a touch layer. The control unit 30 is electrically-connected to the display unit 10 and the sensing unit 20. Referring to FIG. 2, when the display unit 10 is being touched, the control unit 30 is configured to control a plurality of light transmitting holes formed in the touch area to allow fingerprint signals to pass. When the display unit 10 is not being touched, the control unit 30 is configured to control the display unit 10 to display the images. The sensor unit 40 is electrically-connected to the control unit 30, disposed corresponding to the display unit 10, and configured to receive the fingerprint signals passing through the light transmitting holes 4 and to collect fingerprint images.

In the embodiment, the sensor unit 40 includes a plurality of sensors 41 arranged in an array, and the sensors 41 are disposed in one-to-one correspondence with the light transmitting holes 4. The sensors include one of a fingerprint scanner sensor, a camera sensor, a light sensor, and a distance sensor, or includes a combination thereof. Preferably, the sensors 41 are fingerprint scanner sensors.

The sensing unit 20 includes a touch layer to implement sensing of a touch area being touched by the display unit 10 and positioning. The touch mode of the touch layer includes various forms, such as infrared sensing, pressure sensing, and capacitive sensing, wherein this embodiment is preferably pressure sensing. Specific steps are as follows: when the finger presses the screen, the sensing unit 20 starts scanning; the integrated circuit IC acquires the center coordinate (x, y) of the finger and divides the center coordinate of the finger (x, y); the range of the peripheral radius r is the touch area, and the value of the radius r is preferably 10 mm. The control unit 30 controls the touch area to turn on a voltage. Specifically, the voltage is turned on at the position of the pixel unit corresponding to the touch area, and a liquid crystal layer 3 in the touch area forms a plurality of light transmitting holes 4 for transmitting fingerprint signals. Moreover, the control unit 30 controls the sensor unit 40 to scan the fingerprint signals, and finally obtains fingerprint images. In this way, the touch signals of the sensing unit 20 are used to reduce the scanning time of the fingerprint signals. When the finger leaves the display unit 10, that is the display unit 10 not being touched, the control unit 30 controls the display unit 10 to display images.

Referring to FIG. 2, which is a schematic structural view of the display unit 10 and the sensor unit 40 in the touch area, that is, a cross-sectional view showing a display panel. In the embodiment, the display unit 10 includes a first substrate 1, a second substrate 2, and a liquid crystal layer 3 disposed between the first substrate 1 and the second substrate 2. It can be understood that the sensing unit 20 may be disposed on the side of the display unit 10 facing away from the sensor unit 40, or the sensing unit 20 may be integrated with the display unit 10. The disposition is known knowledge and is not redundantly described herein.

In this embodiment, a material of the liquid crystal layer 3 includes a polymer dispersed liquid crystal (PDLC), and the polymer dispersed liquid crystal includes a plurality of liquid crystal molecules and a plurality of reticulated polymers. The first substrate 1 includes an array substrate, and the second substrate 2 includes a color film substrate 21A and a polarizer 22 disposed at a side of the color film substrate 21A facing away from the liquid crystal layer 3.

The polymer dispersed liquid crystal is the material which obtains electro-optic response characteristics by utilizing dielectric anisotropy of liquid crystal molecules. The liquid crystal molecules of the polymer dispersed liquid crystal and the reticulated polymers have different refractive indices. A refractive index difference generated by voltage control of the surface of the liquid crystal and the polymer makes the light passthrough or be scattered on both surfaces, so that a transparent state or a fog state can be realized. The liquid crystal layer 3 can transmit light in the transparent state, and realize scattering of light in the fog state to be used for displaying images. In use, when there is no applied voltage, the optical axes of the liquid crystal molecules are randomly oriented, exhibiting a disordered state, the effective refractive index n0 does not match the refractive index np of the polymer, and the incident light is scattered. The liquid crystal layer 3 is in the fog state (that is, in an opaque or translucent state). When an external voltage is applied, the optical axes of the liquid crystal molecules are arranged perpendicular to the plane of the liquid crystal layer 3, the liquid crystal layer 3 forms light transmitting holes 4 in a transparent state, and the aperture value of the light transmitting holes 4 is preferably 5 um to 50 um.

Specifically, it is assumed that the plane of the liquid crystal layer 3 is horizontal, the specific process of the liquid crystal layer 3 is that the liquid crystal molecules have the same anisotropic dielectric constant as the polymer. When no voltage is applied or the voltage is lower than the threshold voltage, the liquid crystal molecules are horizontally arranged, and there is no refractive index difference between the liquid crystal molecules and the polymer material. Therefore, scattering occurs, and the liquid crystal layer 3 is in the fog state, that is, an opaque or translucent state. When the applied voltage is higher than the threshold voltage, the threshold voltage is preferably 5V. The driving voltage is 5-20V, the liquid crystal molecules are rotated, and the directions are arranged in the vertical direction. The liquid crystal layer 3 forms light transmitting holes 4 in a transparent state, fingerprint signals are transmitted through the light transmitting holes 4, and are received by the sensor unit 40, and the sensor unit 40 collects fingerprint images.

In this embodiment, the light transmitting holes 4 are integrated in the liquid crystal layer 3 of the display unit 10. The sensing unit 20 acquires the touch area when being touched, and the fog state is switched to the transparent state to form the light transmitting holes 4 merely by the control unit 30 turning on the voltage in the touch area. Specifically, the position of the pixel unit corresponding to the touch area is turned on, so that the display unit 10 transmits the fingerprint signals to realize the fingerprint images of the sensing unit 20. When the display unit 10 is not being touched, the control unit 30 controls the display unit 10 to display images. In this embodiment, 100% comprehensive screen fingerprint recognition is realized without affecting the display function, and the screen ratio is improved.

Referring to FIG. 3, the light transmitting area 50 that is preferably fingerprinted in this embodiment is a full screen mode. The light transmitting holes 4 are distributed in an array on the display unit 10.

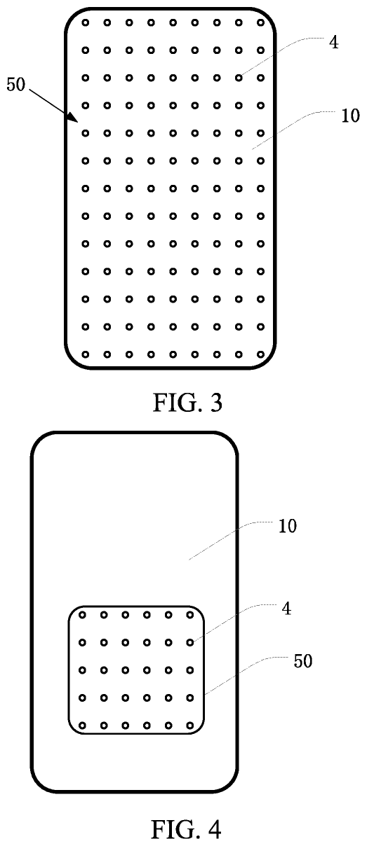

Referring to FIG. 4, in other embodiments, the light transmitting area 50 for fingerprint recognition may also be non-full screen mode. That is, the light transmitting holes 4 are distributed in an array on a certain area on the display unit 10.

### Embodiment 2

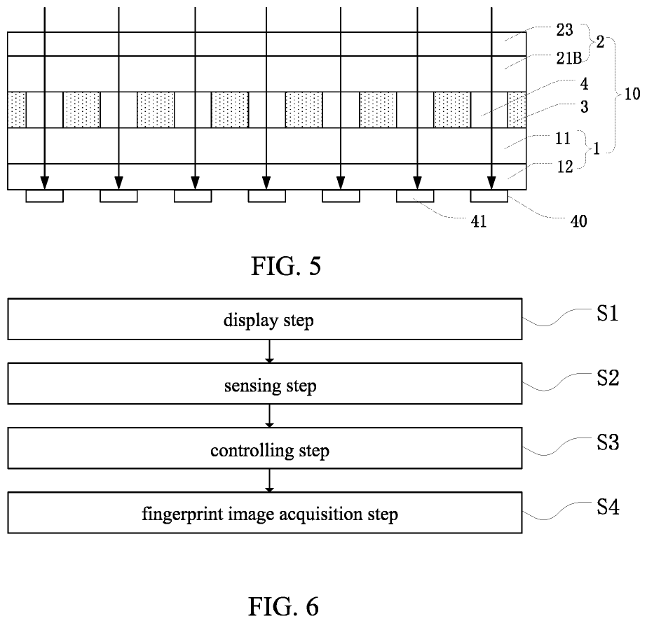

Referring to FIG. 5, all of the technical features in the first embodiment are included in the second embodiment, the difference is that a material of the liquid crystal layer 3 includes thermotropic liquid crystal or lyotropic liquid crystal (ordinary liquid crystal), and the liquid crystal includes a biphenyl liquid crystal, a phenylcyclohexane liquid crystal, or an ester liquid crystal. The first substrate 1 includes an array substrate 11B and a lower polarizer 12 disposed at a side of the array substrate 11B facing away from the liquid crystal layer 3. The second substrate 2 includes a color film substrate 21B and a upper polarizer 23 disposed at a side of the color film substrate 21B facing away from the liquid crystal layer 3. The combination of the liquid crystal molecules with the upper polarizer 23 and the lower polarizer 12 is for the purpose of controlling the light in and out, and is equivalent to a bright/dark image at the time of display.

Referring to FIG. 5, when the display unit 10 is touched, the liquid crystal molecules are rotated after the voltage is applied to the liquid crystal layer 3. A plurality of light transmitting holes 4 are formed in the touch area for transmitting fingerprint signals, wherein the driving voltage applied to the liquid crystal layer 3 is preferably 3-8V. When the display unit 10 is not being touched, it is used to control the display unit 10 to display images. The sensor unit 40 is disposed to correspond to the display unit 10, and configured to receive the fingerprint signals passing through the light transmitting holes 4 (indicated by an arrow in FIG. 5) and to collect fingerprint images.

Similarly, the sensing unit 20 includes a touch layer to implement sensing of a touch area touched by the display unit 10 and positioning. The touch mode of the touch layer includes various forms such as infrared sensing, pressure sensing, and capacitive sensing, wherein this embodiment is preferably pressure sensing. Specific steps are as follows: when the finger presses to the screen, the sensing unit 20 starts scanning; the integrated circuit IC acquires the center coordinate (x, y) of the finger and divides the center coordinate of the finger (x, y); the range of the peripheral radius r is the touch area, and the value of the radius r is preferably 10 mm. The control unit 30 controls the touch area to turn on a voltage. Specifically, the voltage is turned on at the position off the pixel unit corresponding to the touch area, and a liquid crystal layer 3 in the touch area forms a plurality of light transmitting holes 4 for transmitting fingerprint signals. Moreover, the control unit 30 controls the sensor unit 40 to scan the fingerprint signals, and finally obtains fingerprint images. In this way, the touch signals of the sensing unit 20 are used to reduce the scanning time of the fingerprint signals. When the finger leaves the display unit 10, that is the display unit 10 not being touched, the control unit 30 controls the display unit 10 to display images.

Referring to FIG. 6, a flowchart of a control method of a display panel according to an embodiment of the present disclosure is illustrated. The method includes steps S1-S4.

S1, a display step of disposing a display unit 10 being configured to display images.

S2, a sensing step of sensing a touch area where the display unit 10 is touched.

S3, a controlling step of controlling a plurality of light transmitting holes 4 formed in the touch area to cause the display unit 10 being used for fingerprint signals to pass through when the display unit 10 is touched, and controlling the display unit 10 to display the images when the display unit 10 is not being touched.

S4, a fingerprint image acquisition step of receiving the fingerprint signals passing through the light transmitting holes 4, collecting fingerprint images, and returning to the display step after the fingerprint images are collected.

In this embodiment, the controlling step comprises: when the display unit 10 is being touched, applying a voltage to the liquid crystal layer located in the touch area to cause a plurality of liquid crystal molecules to twist to form the light transmitting holes 4 in a transparent state.

Referring to FIG. 2, in this embodiment, the material of the liquid crystal layer 3 includes a polymer dispersed liquid crystal, and the polymer dispersed liquid crystal includes a plurality of liquid crystal molecules and a plurality of reticulated polymers. When there is no applied voltage, the optical axis of the liquid crystal molecules is randomly oriented, exhibiting a disordered state, and the incident light is scattered. The liquid crystal layer 3 is in the fog state, that is, in an opaque or translucent state. When an external voltage is applied, the optical axes of the liquid crystal molecules are arranged perpendicular to the plane of the liquid crystal layer 3, and the liquid crystal layer 3 forms light transmitting holes 4 in a transparent state used for fingerprint signals. Specifically, it is assumed that the plane of the liquid crystal layer 3 is horizontal, the specific process of the liquid crystal layer 3 is that the liquid crystal molecules have the same anisotropic dielectric constant as the polymer. When no voltage is applied or the voltage is lower than the threshold voltage, the liquid crystal molecules are horizontally arranged, and there is no refractive index difference between the liquid crystal molecules and the polymer material. Therefore, scattering occurs, and the liquid crystal layer 3 is in the fog state, that is, an opaque or translucent state. When the applied voltage is higher than the threshold voltage, the threshold voltage is preferably 5V. The driving voltage is 5-20V, the liquid crystal molecules are rotated, and the directions are arranged in the vertical direction. The liquid crystal layer 3 forms light transmitting holes 4 in a transparent state, fingerprint signals are transmitted through the light transmitting holes 4, and are received by the sensor unit 40 and collects fingerprint images.

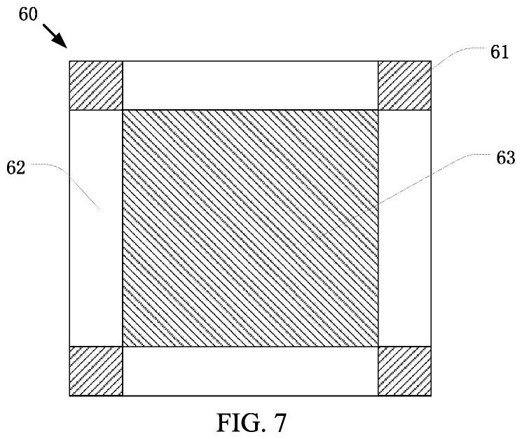

The light transmitting holes 4 are imaged. The image signals collected by the sensor unit 40 are images that are symmetrical with respect to the light transmitting holes 4. The acquisition of fingerprint images involves the flipping and splicing algorithm of the fingerprint image. After each small hole area is transformed into a central symmetry like a square field image. When splicing, select n (preferably n is an integer of 2-5) pixels of the surrounding boundary of each area as contrast pixels of the adjacent area image. The area located at the boundary and the area located at the center have different alignment ranges. It depends on the number of common boundaries between each area and the adjacent area. Referring to FIG. 7, which is a schematic view of a porous splicing boundary of a fingerprint image. The fingerprint image 60 includes an edge stitching 61, wherein the number of borders is 2. The number of boundaries of a convex splicing 62 is 2, and the number of boundaries of a peripheral splicing 63 is 4. After the fingerprint images are flipped and spliced, the fingerprint original images for fingerprint recognition preprocessing are obtained.

Referring to FIG. 5, in other embodiments, the material of the liquid crystal layer 3 includes thermotropic liquid crystal or lyotropic liquid crystal, and the liquid crystal includes a biphenyl liquid crystal, a phenylcyclohexane liquid crystal, or an ester liquid crystal. When the display unit 10 is being touched, the liquid crystal molecules are rotated after the voltage is applied to the liquid crystal layer 3. A plurality of light transmitting holes 4 are formed in the touch area for transmitting fingerprint signals, wherein the driving voltage applied to the liquid crystal layer 3 is preferably 3-8V. When the display unit 10 is not being touched, it is used to control the display unit 10 to display images. The sensor unit 40 is disposed to correspond to the display unit 10, and configured to receive the fingerprint signals passing through the light transmitting holes 4 (indicated by an arrow in FIG. 5) and to collect fingerprint images.

In the embodiment, the fingerprint image acquisition step includes a step of disposing a sensor unit 40. As shown in FIGS. 2 and 5, the sensor unit 40 includes a plurality of sensors 41 arranged in an array, and the sensors 41 are disposed in one-to-one correspondence with the light transmitting holes 4. The sensor 41 includes one of a fingerprint scanner sensor, a camera sensor, a light sensor, and a distance sensor, or includes a combination thereof.

In this embodiment, the light transmitting holes 4 are integrated in the liquid crystal layer 3 of the display unit 10. The sensing unit 20 acquires the touch area when being touched, and the fog state is switched to the transparent state to form the light transmitting holes 4 only by the control unit 30 turning on the voltage in the touch area. Specifically, the voltage of the position of the pixel unit corresponding to the touch area is turned on, so that the display unit 10 transmits the fingerprint signals to realize the fingerprint images of the sensing unit 20. When the display unit 10 is untouched, the control unit 30 controls the display unit 10 to perform to display images. In this embodiment, 100% comprehensive screen fingerprint recognition is realized without affecting the display function, and the screen ratio is improved.

An advantage of the present disclosure is to provide a display panel control system and a display panel control method. The fingerprint images are acquired by detecting the touch area and forming the light transmitting holes in the corresponding touch area, and the images are displayed when the display unit is not being touched.

The present disclosure has been described with preferred embodiments thereof, and it is understood that many changes and modifications to the described embodiments can be carried out without departing from the scope and the spirit of the disclosure that is intended to be limited only by the appended claims.

What is claimed is:

1. A display panel control system, comprising:
a display unit configured to display images;
a sensing unit electrically-connected to the display unit and configured to sense a touch area where the display unit is being touched;
a control unit electrically-connected to the display unit and the sensing unit, wherein the control unit is configured to control a plurality of light transmitting holes formed in the touch area used for fingerprint signals to pass through when the display unit is being touched, and the control unit is configured to control the display unit to display the images when the display unit is not being touched; and
a sensor unit electrically-connected to the control unit, disposed corresponding to the display unit, and configured to receive the fingerprint signals passing through the light transmitting holes and to collect fingerprint images.

2. The display panel control system according to claim 1, wherein the sensor unit includes a plurality of sensors arranged in an array, and the sensors are disposed in one-to-one correspondence with the light transmitting holes.

3. The display panel control system according to claim 2, wherein the sensor includes one of a fingerprint scanner sensor, a camera sensor, a light sensor, and a distance sensor, or includes a combination thereof.

4. The display panel control system according to claim 1, wherein the display unit includes a first substrate, a second substrate disposed opposite to the first substrate, and a liquid crystal layer disposed between the first substrate and the second substrate.

5. The display panel control system according to claim 4, wherein a material of the liquid crystal layer includes a polymer dispersed liquid crystal, and the polymer dispersed liquid crystal includes a plurality of liquid crystal molecules and a plurality of reticulated polymers;
the first substrate includes an array substrate, and
the second substrate includes a color film substrate and a polarizer disposed at a side of the color film substrate facing away from the liquid crystal layer.

6. The display panel control system according to claim 4, a material of the liquid crystal layer includes thermotropic liquid crystal or lyotropic liquid crystal, and the liquid crystal includes a biphenyl liquid crystal, a phenylcyclohexane liquid crystal, or an ester liquid crystal;
the first substrate includes an array substrate and a lower polarizer disposed at a side of the array substrate facing away from the liquid crystal layer, and
the second substrate includes a color film substrate and a upper polarizer disposed at a side of the color film substrate facing away from the liquid crystal layer.

7. A display panel control method, comprising steps of:
a display step of disposing a display unit being configured to display images;
a sensing step of sensing a touch area where the display unit is being touched;
a controlling step of controlling a plurality of light transmitting holes formed in the touch area to cause the display unit being used for fingerprint signals to pass through when the display unit is being touched, and controlling the display unit to display the images when the display unit is not being touched; and
a fingerprint image acquisition step of receiving the fingerprint signals passing through the light transmitting holes, collecting fingerprint images, and returning to the display step after the fingerprint images are collected.

8. The display panel control method according to claim 7, wherein the controlling step comprises: when the display unit is being touched, applying a voltage to the liquid crystal layer located in the touch area to cause a plurality of liquid crystal molecules to twist to form the light transmitting holes in a transparent state.

9. The display panel control method according to claim 8, wherein a material of the liquid crystal layer includes a polymer dispersed liquid crystal, and the polymer dispersed liquid crystal includes the liquid crystal molecules and a plurality of reticulated polymers;
when no voltage is applied, an optical axis of the liquid crystal molecules are randomly oriented to form a disordered state and incident light is scattered, so that the liquid crystal layer is in a fog state;
when a voltage is applied, the optical axis of the liquid crystal molecules are arranged perpendicular to a plane of the liquid crystal layer, so that the liquid crystal layer forms the light transmitting holes being in a transparent state.

10. The display panel control method according to claim 7, wherein the fingerprint image acquisition step includes a step of disposing a sensor unit, and the sensor unit includes a plurality of sensors arranged in an array, and the sensors are disposed in one-to-one correspondence with the light transmitting holes.
